(19) United States
(12) Patent Application Publication
(10) Pub. No.: US 2020/0361194 A1
(43) Pub. Date: Nov. 19, 2020

(54) STACKED STRUCTURE AND WINDOW FOR ELECTRONIC DEVICE AND ELECTRONIC DEVICE

(71) Applicant: SAMSUNG ELECTRONICS CO., LTD., Suwon-si (KR)

(72) Inventors: Jun Cheol BAE, Suwon-si (KR); Cheol HAM, Yongin-si (KR); Ginam KIM, Seongnam-si (KR)

(21) Appl. No.: 16/686,626

(22) Filed: Nov. 18, 2019

(30) Foreign Application Priority Data
May 17, 2019 (KR) 10-2019-0058020

(51) Int. Cl. B32B 27/38; B32B 27/18; C08G 59/30; C08G 59/24; G02B 1/16; G02B 1/14

(52) U.S. Cl. CPC B32B 27/38; B32B 27/18; C08G 59/306; C08G 59/24; G02B 1/16; C08K 5/57; B32B 2307/202; B32B 2305/72; B32B 2457/206; B32B 2255/26; G02B 1/14

(57) ABSTRACT

A stacked structure including a conductive layer disposed on a substrate and a protective layer disposed on the conductive layer and including a cured product of a cation polymerizable compound and a cation initiator, wherein the cation initiator comprises a cation and a resonance-stabilized counteranion, a window for an electronic device, and an electronic device that includes the stacked structure.

### CROSS-REFERENCE TO RELATED APPLICATIONS

This application claims priority to Korean Patent Application No. 10-2019-0058020, filed on May 17, 2019, and all the benefits accruing therefrom under 35 U.S.C. 119, the content of which in its entirety is herein incorporated by reference.

### BACKGROUND

### 1. Field

A stacked structure, a window for an electronic device, and an electronic device are disclosed.

### 2. Description of the Related Art

In any portable electronic device such as a smart phone, a tablet PC, or the like, a display device is required. Of interest are portable devices having a flexible display that is bendable, foldable, or rollable as well as being slim and light.

Currently, the display device mounted on the portable electronic device uses strong glass to protect a display module. However, the glass lacks flexibility and thus is not applicable to a flexible display device. Accordingly, protective polymer films are of interest as an alternative to glass.

### SUMMARY

Polymer films are prone to scratch-like damage due to their low hardness, and can require counter measures against static electricity during process of making an article with the film or the operation of the article. However, scratch resistance characteristics and antistatic characteristics can be difficult to balance and often offset each other.

An embodiment provides a stacked structure capable of simultaneously satisfying scratch resistance characteristics and antistatic characteristics.

Another embodiment provides a window for an electronic device including the stacked structure.

Another embodiment provides an electronic device including the stacked structure or the window for an electronic device.

According to an embodiment, a stacked structure includes a conductive layer disposed on a substrate and a protective layer disposed on the conductive layer and including a cured product of a cation polymerizable compound and a cation initiator, wherein the cation initiator includes a cation and a resonance-stabilized counteranion.

The resonance-stabilized counteranion of the cation initiator may be represented by Chemical Formula 1.

M—(Ar)ₙ Chemical Formula 1

In Chemical Formula 1,

M is B, P, or Sb,

Ar is a C6 to C20 aryl group substituted with at least one halogen, and

n is an integer of 4 to 6.

The cation of the cation initiator may have a resonance-stabilizing moiety that is the same or different as a resonance-stabilizing moiety of the counteranion.

The cationic polymerizable compound may include at least one of an epoxy group and a vinyl group at the terminal end.

The cation polymerizable compound may include an organic compound including at least one of an epoxy group and a vinyl group at the terminal end, an organosiloxane including at least one of an epoxy group and a vinyl group at the terminal end, or a combination thereof.

The cation polymerizable compound may include a substituted or unsubstituted epoxy group, a substituted or unsubstituted glycidyl group, a substituted or unsubstituted glycidyl ether group, a substituted or unsubstituted glycidyl ester group, a substituted or unsubstituted oxetanyl group, a substituted or unsubstituted epoxycycloalkyl group, a substituted or unsubstituted vinyl group, a substituted or unsubstituted vinyl ether group, a substituted or unsubstituted styrenyl group, or a combination thereof.

The conductive layer may have a sheet resistance of less than or equal to about 8×10¹⁰ ohms per square (Ω/sq).

The conductive layer may include a metal, a carbon body, a conductive nanostructure, a conductive oxide, a conductive low molecule, a conductive polymer, ionic liquid, or a combination thereof. Moreover, the conductive layer has a sheet resistance of less than or equal to about 8×10¹⁰ Ω/sq.

The conductive layer may be thinner than the protective layer.

The substrate may be a polymer substrate.

The stacked structure may have a sheet resistance of less than about 10¹¹Ω/sq.

The sheet resistance of the stacked structure may be about 1.1 times to about 30 times the sheet resistance of the conductive layer.

The stacked structure may satisfy a transmittance at about 550 nanometers (nm) of greater than or equal to about 88% and a haze of less than or equal to about 1.0.

According to another embodiment, a window for an electronic device includes the stacked structure.

According to another embodiment, an electronic device includes the stacked structure or the window for an electronic device.

According to another embodiment, a method of manufacturing a stacked structure includes forming a conductive layer on a substrate, coating the conductive layer with a composition for a protective layer, and curing the composition to form a protective layer, wherein the composition for the protective layer includes a cation polymerizable compound and a cation initiator including a cation and a resonance-stabilized counteranion.

Scratch resistance characteristics and antistatic characteristics may be satisfied simultaneously.

### BRIEF DESCRIPTION OF THE DRAWINGS

FIG. 1 is a cross-sectional view that schematically shows an example of a stacked structure according to an embodiment,

FIG. 2 is a cross-sectional view that schematically shows another example of a stacked structure according to an embodiment,

FIG. 3 is a cross-sectional view that schematically shows an example of a display device according to an embodiment, and

FIG. 4 is a cross-sectional view that schematically shows another example of a display device according to an embodiment.

### DETAILED DESCRIPTION

Hereinafter, example embodiments of the present disclosure will be described in detail so that a person skilled in the art would understand the same. This disclosure may, however, be embodied in many different forms and is not construed as limited to the example embodiments set forth herein.

The invention will be described more fully hereinafter with reference to the accompanying drawings, in which various embodiments are shown. Rather, these embodiments are provided so that this disclosure will be thorough and complete, and will fully convey the scope of the invention to those skilled in the art.

In the drawings, the thickness of layers, films, panels, regions, etc., are exaggerated for clarity. Like reference numerals designate like elements throughout the specification. Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The terminology used herein is for the purpose of describing particular embodiments only and is not intended to be limiting. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

In the drawings, parts having no relationship with the description are omitted from the drawings for clarity of the embodiments, and the same or similar constituent elements are indicated by the same reference numeral throughout the specification. As used herein, “combination” refers to a mixture of two or more and a stack structure of two or more.

As used herein, when a definition is not otherwise provided, “substituted” refers to replacement of a hydrogen atom of a compound by a substituent of a halogen atom, a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C3 to C30 heteroaryl group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, or a combination thereof. As used herein, when a definition is not otherwise provided, “hetero” refers to one including 1 to 3 heteroatoms of N, O, S, P, or Si.

As used herein, the term “resonance-stabilized” means an organic or inorganic anion or an organic or inorganic cation having an organic moiety that can be depicted with two or more resonance structures, with the negative or positive charge localized on at least two different atoms of the organic moiety. As would be understood by one of ordinary skill in the art, such organic moieties provide resonance stabilization of the anion or cation. These moieties are often conjugated, such that a resonance-stabilized anion or cation may include a conjugated moiety.

As used herein the term “counteranion” means an anion that is associated with an organic or inorganic cation to provide the cation initiator.

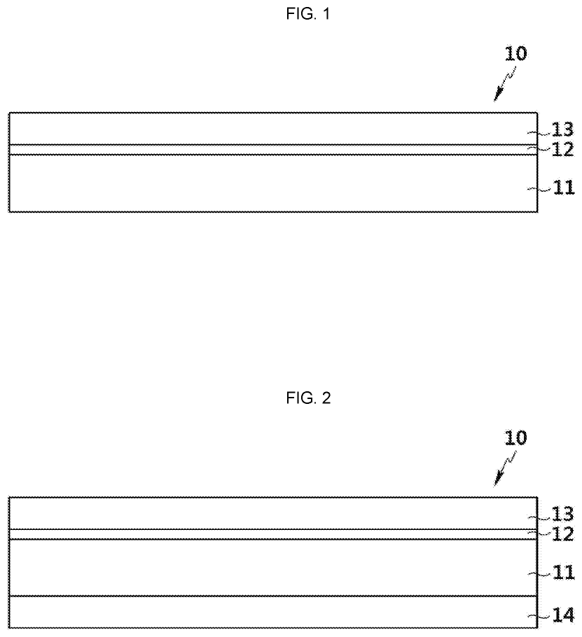

Hereinafter, a stacked structure according to an embodiment is described. FIG. 1 is a cross-sectional view that schematically shows an example of a stacked structure according to an embodiment. Referring to FIG. 1, a stacked structure 10 according to an embodiment includes a substrate 11, a conductive layer 12, and a protective layer 13. The substrate 11 may be a glass or polymer substrate. The polymer substrate may include, for example, polyimide, polyamide, poly(amide-imide), polyethylene terephthalate, polyethylene naphthalene, polymethylmethacrylate, polycarbonate, a copolymer thereof, or a combination thereof, but is not limited thereto.

The substrate 11 may be a transparent substrate and may have for example a light transmittance at a wavelength of 550 nm of greater than or equal to about 85% and a yellow index of less than or equal to about 3.0. Within the ranges, it may have for example a light transmittance at a wavelength of 550 nm of greater than or equal to about 87%, greater than or equal to about 88%, greater than or equal to about 89%, or greater than or equal to about 90% and a yellow index of less than or equal to about 2.5, less than or equal to about 2.0, less than or equal to about 1.5, less than or equal to about 1.0, or less than or equal to about 0.8. The substrate 11 may have for example a thickness of about 10 micrometers (μm) to about 150 μm, for example about 25 μm to about 150 μm, or about 30 μm to about 100 μm.

The conductive layer 12 is a layer having conductivity and may have a sheet resistance of less than or equal to about 8×10¹⁰ ohms per square (Ω/sq).

The sheet resistance may be a value measured with a sheet resistance meter (MCP-HT450, Mitsubishi Chemical Analytech). Within the range, the conductive layer 12 may have a sheet resistance of less than or equal to about 7×10¹⁰ Ω/sq., less than or equal to about 6×10¹⁰ Ω/sq., or less than or equal to about 5×10¹⁰ Ω/sq., for example about 1×10⁹ Ω/sq. to about 8×10¹⁰ Ω/sq., about 1×10⁹ Ω/sq. to about 7×10¹⁰ Ω/sq., about 1×10⁹ Ω/sq. to about 6×10¹⁰ Ω/sq., or about 1×10⁹ Ωsq. to about 5×10¹⁰ Ω/sq.

The conductive layer 12 may be a transparent layer with a sheet resistance within the ranges.

The conductive layer 12 may include a conductive material having a sheet resistance within the ranges, for example an organic material, an inorganic material, an organic/inorganic material, or a combination thereof, for example, a metal, a carbon body, a conductive nanostructure, a conductive oxide, a conductive low molecule, a conductive polymer, ionic liquid, or a combination thereof. The metal, carbon body, conductive nanostructure, conductive oxide, conductive low molecule, conductive polymer, ionic liquid, or combination thereof may form a transparent layer.

For example, the metal may be silver, gold, aluminum, titanium, nickel, tin, tantalum, or a combination thereof.

For example, the carbon body may be graphene, carbon nanotube, or a combination thereof.

For example, the conductive nanostructure may be a conductive nanotube, a conductive nanowire, a conductive nanoparticle, a conductive nanorod, a conductive nanoflake, a conductive nanocapsule, a conductive nanocrystal, a quantum dot, or a combination thereof.

For example, the conductive oxide may be an indium tin oxide (ITO), an indium zinc oxide (IZO), a zinc oxide (ZnO), a tin oxide (SnO₂), an aluminum-doped tin oxide (ATO), an aluminum-doped zinc oxide (AZO), a fluorine-doped tin oxide (FTO), a phosphorus-doped tin oxide (PTO), or a combination thereof.

For example, the conductive low molecule may be pyridinium, imidazolium, phosphonium, ammonium, bis(trifluoromethanesulfonyl)imide, or a lithium salt of bis(trifluorosulfonyl)imide, or a combination thereof.

For example, the conductive polymer may be poly(3,4-ethylenedioxythiophene) (PEDOT), polystyrene sulfonate (PSS), poly(3,4-ethylenedioxythiophene)polystyrene sulfonate (PEDOT:PSS), polythiophene, poly(9,9-dioctyl-fluorene-co-N-(4-butylphenyl)-diphenylamine) (TFB), polyarylamine, poly(N-vinylcarbazole), polyaniline, polypyrrole, N,N,N′,N′-tetrakis(4-methoxyphenyl)-benzidine (TPD), 4-bis[N-(1-naphthyl)-N-phenyl-amino]biphenyl (α-NPD), m-MTDATA (4,4′,4″-tris[phenyl(m-tolyl)amino]triphenylamine), 4,4′,4″-tris(N-carbazolyl)-triphenylamine (TCTA), 1,1-bis[(di-4-tolylamino)phenylcyclohexane (TAPC), polyfluorene, poly(p-phenylenevinylene), a derivative thereof, or a combination thereof.

For example, the ionic liquid may be 1-butyl-3-methylimidazolium hexafluorophosphate (BMIm PF₆), 1-ethyl-3-methylimidazolium tetrafluoroborate (EMIm BF₄), or 1-butyl-3-methylimidazolium bis(trifluoromethylsulfonyl)amide (BMIm TFSI).

The conductive layer 12 may further include a polymerizable compound in addition to the aforementioned conductive material. The polymerizable compound may be a thermosetting compound or a photocurable compound.

The conductive layer 12 may be thinner than the protective layer 13 that will be described later, and may have a thickness of less than or equal to about 2 micrometers (μm). Within the range, it may have a thickness about 30 nm to about 2 μm, about 50 nm to about 2 μm, about 100 nm to about 2 μm, about 200 nm to about 2 μm, about 300 nm to about 2 μm, about 500 nm to about 2 μm, about 30 nm to about 1.5 μm, about 50 nm to about 1.5 μm, about 100 nm to about 1.5 μm, about 200 nm to about 1.5 μm, about 300 nm to about 1.5 μm, or about 400 nm to about 1.5 μm.

The protective layer 13 is a layer for protecting the substrate 11 from mechanical physical damage, and may be for example a hard coating layer, a scratch-resistance layer, a high hardness layer, and/or a fingerprint-resistance layer, but is not limited thereto. For example, the protective layer 13 may be on the conductive layer 12. Alternatively, the protective layer 13 may be directly on the conductive layer, i.e., in contact with the conductive layer 12 as shown in FIG. 1.

The protective layer 13 may be a transparent protective layer and may be a coating layer obtained by coating and curing a composition for a protective layer.

The composition for the protective layer includes a cation polymerizable compound and a cation initiator as described herein.

The cationic polymerizable compound may include an organic compound and/or an organic/inorganic compound having a functional group capable of being polymerized according to a cationic polymerization mechanism. For example, a cation polymerizable compound may include an organic compound and/or an organic/inorganic compound having which have at least one of an epoxy group and a vinyl group. The organic compound may include for example a monomer, an oligomer, and/or a polymer and the organic/inorganic compound may include for example an organosiloxane such as silsesquioxane.

For example, the cation polymerizable compound may have one or more epoxy groups.

For example, the cation polymerizable compound may include an organic compound having one or more epoxy groups.

For example, the cation polymerizable compound may include an organosiloxane having one or more epoxy groups.

For example, the cation polymerizable compound may include an organic compound having one or more epoxy groups and organosiloxane having one or more epoxy groups.

For example, the cation polymerizable compound may include a substituted or unsubstituted epoxy group, a substituted or unsubstituted glycidyl group, a substituted or unsubstituted glycidyl ether group, a substituted or unsubstituted glycidyl ester group, a substituted or unsubstituted oxetanyl group, a substituted or unsubstituted epoxycycloalkyl group, a substituted or unsubstituted vinyl group, a substituted or unsubstituted vinyl ether group, a substituted or unsubstituted styrenyl group, or a combination thereof, but is not limited thereto.

For example, the cationic polymerizable compound may include one or more organic compounds, and at least one of the organic compounds may be represented by one of Chemical Formulae A and B, but is not limited thereto.

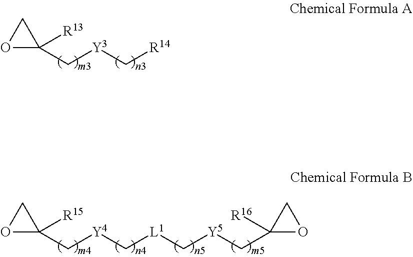

In Chemical Formula A or B,

Y³, Y⁴, and Y⁵ may each independently be O, C(═O), C(═O)O, or OC(═O),

R¹³, R¹⁵, and R¹⁶ may be hydrogen or a methyl group,

R¹⁴ may be a substituted or unsubstituted Cl to C30 alkyl group, a substituted or unsubstituted C3 to C30 cycloalkyl group, a substituted or unsubstituted C2 to C30 heterocycloalkyl group, a substituted or unsubstituted C6 to C30 aryl group, a substituted or unsubstituted C3 to C30 heteroaryl group, or a combination thereof,

L¹ may be a substituted or unsubstituted C1 to C30 alkylene group, a substituted or unsubstituted C3 to C30 cycloalkylene group, a substituted or unsubstituted C2 to C30 heterocycloalkylene group, a substituted or unsubstituted C6 to C30 arylene group, a substituted or unsubstituted C3 to C30 heteroarylene group, or a combination thereof,

m3, m4, and m5 may each independently be an integer of 1 to 3, and

n3, n4, and n5 may each independently be an integer of 0 to 10, or each independently an integer of 1 to 6.

For example, in Chemical Formula A, R¹⁴ may be a substituted or unsubstituted C1 to C30 alkyl group, a substituted or unsubstituted C3 to C30 cycloalkyl group, or a substituted or unsubstituted C6 to C30 aryl group.

For example, in Chemical Formula A, R¹⁴ may be a substituted or unsubstituted C3 to C30 cycloalkyl group, or a substituted or unsubstituted C6 to C30 aryl group, for example R¹⁴ may be a substituted or unsubstituted phenyl group, a substituted or unsubstituted naphthyl group, a substituted or unsubstituted biphenyl group, or a substituted or unsubstituted cyclohexyl group, but is not limited thereto.

For example, in Chemical Formula B, L¹ may be a substituted or unsubstituted C1 to C30 alkylene group, a substituted or unsubstituted C3 to C30 cycloalkylene group, or a substituted or unsubstituted C6 to C30 arylene group.

For example, in Chemical Formula B, L¹ may be a substituted or unsubstituted C3 to C30 cycloalkylene group or a substituted or unsubstituted C6 to C30 arylene group.

For example, the cation polymerizable compounds may be at least one of the compounds of Group 1 below, but is not limited thereto.

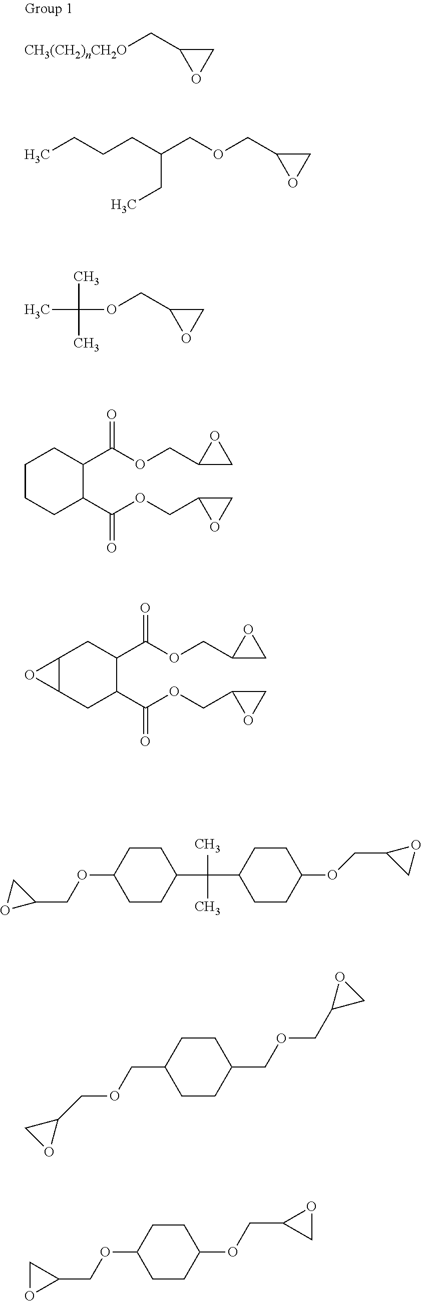

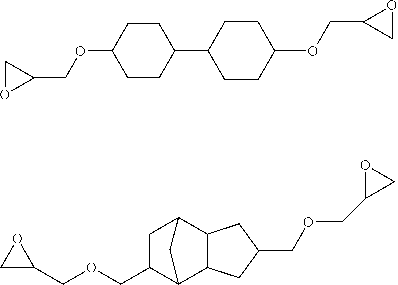 [SMILES: C1CC(C2CCC(OCC3CO3)CC2)CCC1OCC1CO1 ; C(OCC1CO1)C1CC2C3CC(COCC4CO4)C(C3)C2C1]

For example, the cationic polymerizable compound may include one or more organosiloxanes, and at least one of the organosiloxanes may be represented by Chemical Formula C, but is not limited thereto.

(R^{a}R^{b}R^{c}Si_{1/2})_{M1}(R^{d}R^{e}SiO_{2/2})_{D1}(R^{f}SiO_{3/2})_{T}1a(R^{g}SiO_{3/2})_{T1b}(R^{h}SiO_{3/2})_{T1c}(SiO_{4/2})_{Q1} Chemical Formula C

In Chemical Formula C,

R^{a} to R^{h} may each independently be hydrogen, a substituted or unsubstituted C1 to C30 alkyl group, a substituted or unsubstituted C1 to C30 alkenyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkynyl group, a substituted or unsubstituted C1 to C30 alkoxy group, a substituted or unsubstituted C1 to C30 carbonyl group, epoxy group, a hydroxy group, or a combination thereof,

at least one of R^{a} to R^{h} may include at least one of a substituted or unsubstituted C1 to C30 alkenyl group and an epoxy group,

0≤M1≤0.4, 0≤D1≤0.4, 0≤T1a<1, 0≤T1b<1, 0≤T1c≤1, 0≤Q1≤0.4, and M1+D1+T1a+T1b+T1c+Q1=1.

For example, the organosiloxane may include silsesquioxane and the silsesquioxane may be represented by the Chemical Formula C-1 but is not limited thereto.

(R^{a}R^{b}R^{c}SiO_{1/2})M1(R^{d}R^{e}SiO_{2/2})_{D1}(R^{f}SiO_{3/2})_{T1a}(R^{g}SiO_{3/2})_{T1b}(R^{h}SiO_{3/2})_{T1c}(SiO_{4/2})_{Q1} Chemical Formula C-1

In Chemical Formula C-1,

R^{a} to R^{g} may be the same as described above,

R^{h} may include at least one of a substituted or unsubstituted C1 to C30 alkenyl group and an epoxy group,

0≤M1≤0.4, 0≤D1≤0.4, 0T1a<1, 0≤T1b<1, 0<T1c≤1, and 0≤Q1≤0.4, provided that 0.6≤T1a+T1b+T1c≤1, and

M1+D1+T1a+T1b+T1c+Q1=1.

For example, R^{h} of Chemical Formula C-1 may be a functional group represented by Chemical Formula C-1-a.

R¹-(CH2)ₙ₁−* Chemical Formula C-1-a

In Chemical Formula C-1-a,

R¹ may be a functional group including an epoxy group or a vinyl group, for example a substituted or unsubstituted epoxy group, a substituted or unsubstituted glycidyl group, a substituted or unsubstituted glycidyl ether group, a substituted or unsubstituted glycidyl ester group, a substituted or unsubstituted oxetanyl group, a substituted or unsubstituted epoxycycloalkyl group, a substituted or unsubstituted vinyl group, a substituted or unsubstituted vinyl ether group, a substituted or unsubstituted styrenyl group, or a combination thereof,

n1 may be an integer of 1 to 30, or an integer of 1 to 12, and

* may be a linking point with Si.

For example, R^{h} of Chemical Formula C-1 may be a functional group represented by Chemical Formula C-1-aa.

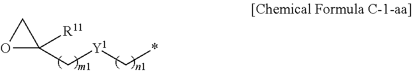

In Chemical Formula C-1-aa,

Y¹ may be O, C(═O), C(═O)O, or OC(═O),

R¹¹ may be hydrogen or a methyl group,

m1 may be an integer of 1 to 3,

n1 may be an integer of 1 to 30, or an integer of 1 to 12, and

* may be a linking point with Si.

The cation polymerizable compound may be included in an amount of about 5 weight percent (wt %) to about 95 wt %, for example about 5 wt % to about 90 wt %, about 10 wt % to about 85 wt %, or about 10 wt % to about 80 wt % based on a total amount of the composition for the protective layer.

The cation initiator may be a material that initiates a polymerization reaction of the aforementioned polymerizable compound and may be a photo acid generator (PAG) that produces acid after the reaction. The cation initiator may be a cation photopolymerization initiator or a cation photocuring initiator.

The cation initiator may include for example an anion and a cation.

The counteranion of the cation initiator may include a resonance-stabilized moiety, which may be a conjugated moiety, for example a substituted or unsubstituted aryl group or a substituted or unsubstituted heteroaryl group. For example, the counteranion of the cation initiator may include an aryl group substituted with a halogen or a heteroaryl group substituted with a halogen, and may be for example a borate, a phosphate, or an antimonite including an aryl group substituted with a halogen or a heteroaryl group substituted with a halogen. For example, the counteranion of the cation initiator may be a borate, a phosphate, or an antimonite including a phenyl group substituted with a halogen.

For example, the counteranion of the cation initiator may be represented by Chemical Formula 1.

M—(Ar)ₙ Chemical Formula 1

In Chemical Formula 1,

M may be B, P, or Sb,

Ar may be a C6 to C20 aryl group substituted with at least one halogen or a C3 to C20 heteroaryl group substituted with at least one halogen, for example a C6 to C20 aryl group substituted with at least one halogen,

n may be an integer of 4 to 6.

For example, the cation initiator may be a borate, a phosphate, or an antimonite including a phenyl group substituted with at least two fluorine atoms, for example a borate, a phosphate, or an antimonite including a phenyl group substituted with five fluorine atoms. The cation of the cation initiator is not particularly limited, but may include a resonance-stabilized or conjugated moiety that is the same as or different from the resonance-stabilized or conjugated moiety of the counteranion. The cation of the cation initiator may include for example a substituted or unsubstituted aryl group or a substituted or unsubstituted heteroaryl group, for example a substituted or unsubstituted phenyl group, for example an iodonium, a sulfonium, or a sulfide including a phenyl group substituted with a C1 to C30 alkyl group. The cation of the cation initiator may be for example diphenyliodonium, alkyl substituted diphenyliodonium, 4-methoxydiphenyliodonium, bis(4-methylphenyl)iodonium, bis(4-t-butylphenyl)iodonium, bis(dodecylphenyl)iodonium, triphenylsulfonium, diphenyl-4-thiophenoxyphenylsulfonium, bis[4-diphenylsulfonio)phenyl]sulfide, bis[4-(di(4-(2-hydroxyethyl)phenyl)sulfonio)-phenyl]sulfide, or a combination thereof, but is not limited thereto.

The cation initiator may be included in an amount of about 0.01 parts by weight to about 20 parts by weight, for example about 0.1 parts by weight to about 10 parts by weight, or about 0.1 parts by weight to about 5 parts by weight based on 100 parts by weight of the cation polymerizable compound.

The composition for the protective layer may further include an additive such as a polymerization accelerator and/or an ultraviolet (UV) absorber.

The composition for the protective layer may further include a solvent capable of dissolving or dispersing the aforementioned components. The solvent is not particularly limited as long as it may dissolve and/or disperse the aforementioned components. However, the solvent may be for example water; an alcohol-based solvent such as methanol, ethanol, n-propyl alcohol, isopropyl alcohol, n-butanol, isobutanol, t-butanol, propylene glycol, propylene glycol methyl ether, ethylene glycol, and the like; an aliphatic hydrocarbon solvent such as hexane, heptane and the like; an aromatic hydrocarbon solvent such as toluene, pyridine, quinoline, anisole, mesitylene, xylene, and the like; a ketone-based solvent such as methyl isobutyl ketone, 1-methyl-2-pyrrolidinone (NMP), cyclohexanone, acetone, and the like; an ether-based solvent such as tetrahydrofuran, isopropyl ether, and the like; an acetate-based solvent such as ethyl acetate, butyl acetate, propylene glycol methyl ether acetate, and the like; an amide-based solvent such as dimethyl acetamide, dimethyl formamide (DMF), and the like; a nitrile-based solvent such as acetonitrile, benzonitrile, and the like; and a mixture of the foregoing solvents, but is not limited thereto.

The solvent may be included in a balance amount excluding the aforementioned solid components.

The composition for the protective layer may be formed into the protective layer 13 by coating, drying, and curing. The composition for the protective layer may be for example coated with a solution process, for example a spin coating, a slit coating, a bar coating, a dip coating, a spray coating, an inkjet printing, and the like, but is not limited thereto. The drying may be for example once or more than once performed at about 70° C. to about 150° C. The curing may be photo curing and/or thermal curing. The photo curing may for example use a xenon lamp, a high pressure mercury lamp, a metal halide lamp, and the like and the thermal curing may be for example performed at about 80° C. to about 200° C. Additional heat-treatment may be available after curing and the heat-treatment may be performed for example at about 50° C. to about 200° C., for example about 70° C. to about 180° C. and for example at about 80° C. to about 160° C.

The protective layer 13 may include a cured product of the composition for the protective layer and may be a transparent layer.

The protective layer 13 may be thicker than the conductive layer 12, and may have a thickness of about 1 μm to about 20 μm, about 2 μm to about 20 μm, or about 3 μm to about 20 μm.

As described above, the protective layer 13 is a coating layer obtained by coating and curing the composition for the protective layer, wherein the composition for a protective layer includes a cation initiator including a resonance-stabilized counteranion, for example counterion having a conjugated moiety, and thus may facilitate a charge separation in the protective layer 13, and as a result, the separated charges may more easily escape through the conductive layer 12 disposed near the protective layer 13, and accordingly, improved antistatic characteristics may be obtained.

Thus, when the stacked structure 10 is applied as a window for an electronic device, static electricity generated during or during processes may be easily escaped through the protective layer 13 and conductive layer 12, thereby reducing or preventing defects due to the static electricity.

Therefore, the stacked structure 10 may have scratch resistance characteristics that effectively reduce or prevent external stimulus damages and simultaneously may have an improved antistatic effect by effectively removing static electricity by the combination of the protective layer 13 and the conductive layer 12. Accordingly, the stacked structure 10 may simultaneously satisfy scratch resistance characteristics and antistatic characteristics in a trade-off relationship.

For example, the stacked structure 10 may have a sheet resistance of less than about 10¹¹ Ω/sq., for example greater than about 10 Ω/sq. and less than about 10¹¹ Ω/sq., about 5×10⁹ Ω/sq. to about 9×10¹⁰ Ω/sq., or about 10¹⁰ Ω/sq. to about 8×10¹⁰ Ω/sq.

For example, the sheet resistance of the stacked structure 10 may be about 1.1 times to about 30 times, about 1.1 times to about 20 times, about 1.1 times to about 15 times, or about 1.1 times to about 10 times the sheet resistance of the conductive layer 12.

The stacked structure 10 may have a transmittance at 550 nm of greater than or equal to about 88% and a haze of less than or equal to about 1. Within the ranges, it may have for example a transmittance at 550 nm of greater than or equal to about 89% and a haze of less than or equal to about 0.9, for example a transmittance at 550 nm of greater than or equal to about 90% and a haze of less than or equal to about 0.8, or a transmittance at 550 nm of greater than or equal to about 90% and a haze of less than or equal to about 0.7.

For example, the stacked structure 10 may have a pencil hardness of greater than or equal to about 3 H, for example greater than or equal to about 4 H, greater than or equal to about 5 H, or greater than or equal to about 6 H. Herein the pencil hardness is a value measured by a pencil hardness measurer (an automatic pencil scratch hardness tester No. 553-M1, YASUDA SEIKI SEISAKUSHO LTD.) and a Mitsubishi pencil according to ASTM D3363 standard.

For example, the stacked structure 10 may be a flexible stacked structure which may be bent, folded, or rolled to have a curvature radius (r) of for example, less than or equal to about 5 millimeters (mm), less than or equal to about 3 mm, less than or equal to about 2 mm, or less than or equal to about 1 mm.

The stacked structure 10 may be formed as a film and thus used as a flexible transparent film and applied to, for example, a window for an electronic device. The stacked structure 10 simultaneously satisfies scratch resistance characteristics, antistatic characteristics, and flexibility as described above and thus may be effectively applied to an electronic device such as a bendable, foldable, or rollable display device.

FIG. 2 is a cross-sectional view that schematically shows another example of a stacked structure according to an embodiment.

Referring to FIG. 2, a stacked structure 10 according to the present embodiment includes a substrate 11, a conductive layer 12, and a protective layer 13, like the aforementioned embodiment. However, the stacked structure 10 according to the present embodiment further includes a buffer layer 14 on a surface of the substrate 11 opposite that of the conductive layer. The buffer layer 14 is disposed under the substrate 11 and may absorb and/or reduce an impact transferred to the lower side of the substrate 11. Accordingly, when the stacked structure 10 is applied to a window for an electronic device on a display panel such as a liquid crystal panel or an organic light emitting panel which will be described later, an impact transferred from the stacked structure 10 toward the display panel may be reduced or prevented and thus effectively protect the display device.

The stacked structure 10 may be applied to various display devices as a window for an electronic device. The display device may be for example a liquid crystal display (LCD), an organic light emitting diode (OLED) display, or a quantum dot display device, but is not limited thereto. The display device may be for example a bendable display device, a foldable display device, or a rollable display device. For example, the window of the electronic device may be associated with an organic light emitting diode display, a bendable organic light emitting diode display device, a foldable organic light emitting diode display device, or a rollable organic light emitting diode display device, a quantum dot display device, a bendable a quantum dot display device, a quantum dot foldable display device, or a quantum dot rollable display device.

As noted above, the stacked structure 10 may be attached on the display panel. Herein, the display panel and the stacked structure 10 may be directly bonded or may be bonded by interposing a tackifier or an adhesive.

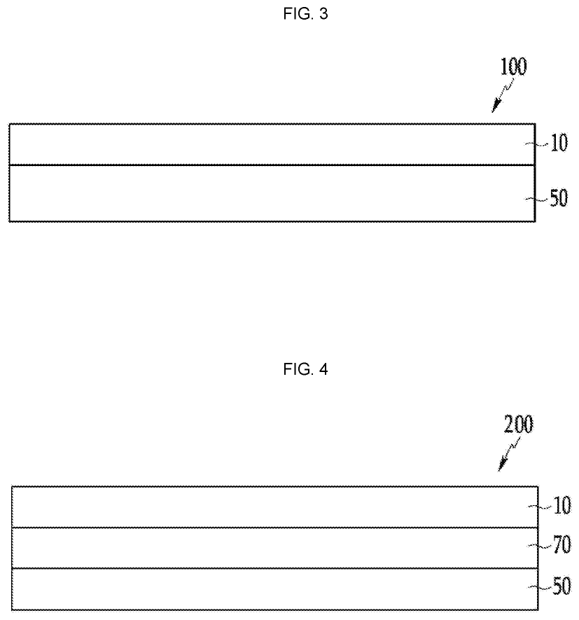

FIG. 3 is a cross-sectional view that schematically shows an example of a display device according to an embodiment.

Referring to FIG. 3, a display device 100 according to an embodiment includes a display panel 50, a stacked structure 10, and an adhesion layer (not shown).

The display panel 50 may be for example an organic light emitting display panel, a liquid crystal display panel, or a quantum dot display panel, for example a bendable display panel, a foldable display panel, or a rollable display panel, as noted above

The stacked structure 10 may be disposed on the observer side, and its structure is the same as described above.

The display panel 50 and the stacked structure 10 may be bonded by an adhesion layer. The adhesion layer may include a tackifier or an adhesive, for example optical clear adhesive (OCA). The adhesion layer may be omitted.

Another layer may be further disposed between the display panel 50 and the stacked structure 10 and may include for example a monolayer or plural layers of a polymer layer (not shown) and optionally a transparent adhesion layer (not shown).

FIG. 4 is a cross-sectional view that schematically shows another example of a display device according to an embodiment.

Referring to FIG. 4, the display device 200 according to the present embodiment includes a display panel 50, a stacked structure 10, an adhesion layer 17, and a touch panel 70 disposed between the display panel 50 and the stacked structure 10.

The display panel 50 may be for example an organic light emitting panel, a liquid crystal panel, or a quantum dot display panel, for example a bendable display panel, a foldable display panel, or a rollable display panel, as noted above.

The stacked structure 10 may be disposed on the observer side, and its structure is the same as described above.

The touch panel 70 may be disposed adjacent to each of the stacked structure 10 and the display panel 50 to recognize the touched position and the position change when is touched by a human hand or an object through the stacked structure 10 and then to output a touch signal. The driving module (not shown) may monitor a position where is touched from the output touch signal; recognize an icon marked at the touched position, and control to carry out functions corresponding to the recognized icon, and the function performance results are displayed on the display panel 50.

Another layer may be further disposed between the touch panel 70 and the stacked structure 10 and may include for example a monolayer or plural layers of a polymer layer (not shown) and optionally a transparent adhesion layer (not shown).

The display device may be applied to various electronic devices, for example smart phones, tablet PCs, laptop computers, cameras, touch screen devices, but is not limited thereto.

Hereinafter, the embodiments are illustrated in more detail with reference to examples. However, these examples are exemplary, and the present disclosure is not limited thereto.

### SYNTHESIS EXAMPLE

20 milliliters (ml) of ethyl alcohol (Samchun Chemicals) and 17.5 grams (g) of a 1 weight percent (wt%) tetramethylammonium hydroxide solution (Sigma-Aldrich Co., Ltd.) are put in a 100 ml double-jacketed reaction vessel and mixed. As the solution is mixed, 26.5 ml of (3-glycidyloxypropyl)trimethoxysilane (Sigma-Aldrich Co., Ltd.) is added thereto and mixed at room temperature for 6 hours. The temperature is then increased to 60° C., and 40 ml of toluene (Sigma-Aldrich Co., Ltd.) is added and mixed for 6 hours. When the mixing is complete, the reaction product solution is washed by using a saturated sodium chloride solution (Samchun Chemicals), and residual moisture is removed therefrom by using anhydrous sodium sulfate (Samchun Chemicals). The residual solvent is removed from the separated organic fraction such as toluene and the like remaining in the reaction product with an evaporator (Daihan Scientific Co.) and a vacuum oven (Daihan Scientific Co.) to obtain silsesquioxane having the following structure.

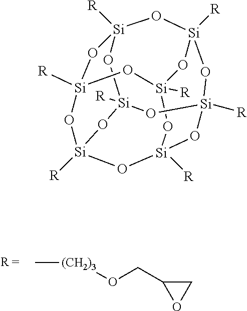

### PREPARATION EXAMPLES

### Preparation Example 1: Preparation of Composition for Conductive Layer

3.45 g of PEDOT:PSS (AS-100 A, DaeHa ManTech Co., Ltd.) dispersed in an organic solvent and 1.2 g of multi-functional urethane acrylate (PU610, Miwon Specialty Chemical Co., Ltd.) are dissolved in an organic solvent (a mixed solvent of 2.6 g of propylene glycol methyl ether (PGME) and 1.3 g of methylethylketone (MEK)), and 2 parts by weight of Irgacure 184 as a UV photoinitiator based on 100 parts by weight of the multi-functional urethane acrylate is added thereto to prepare a composition for a conductive layer.

### Preparation Example 2: Preparation of Composition for Conductive Layer

3.45 g of aluminum-doped tin oxide (ATO) (KO-606 A, DaeHa ManTech Co., Ltd.) dispersed in an organic solvent and 1.2 g of multi-functional urethane acrylate (PU610, Miwon Specialty Chemical Co., Ltd.) are dissolved in an organic solvent (a mixed solvent of 2.6 g of PGME and 1.3 g of (MEK), and 2 parts by weight of Irgacure 184 as a UV photoinitiator based on 100 parts by weight of the multi-functional urethane acrylate is added thereto to prepare a composition for a conductive layer.

### Preparation Example 3: Preparation of Composition for Protective Layer

4 g of the silsesquioxane according to Synthesis Example and 1 g of 2-ethylhexyl glycidyl ether (Sigma-Aldrich Co., Ltd.) are added to methylisobutylketone and stirred. Herein, the silsesquioxane and the 2-ethylhexyl glycidyl ether make up 50 wt % based on a total weight of the solution. 2.5 parts by weight of a cation initiator represented by Chemical Formula X based on 100 parts by weight of solids is added thereto and then mixed until the mixture becomes uniform to provide a composition for a protective layer.

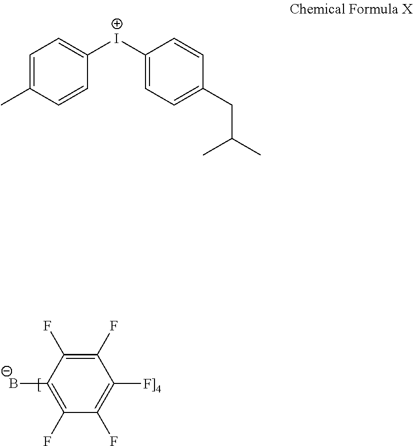

### Comparative Preparation Example 1: Preparation of Composition for Protective Layer

5 g of multi-functional urethane acrylate (MU9800, Miwon Specialty Chemical Co., Ltd.) is added to 5 g of methylisobutylketone, and 2.5 parts by weight of Irgacure 184 as a photopolymerization initiator based on 100 parts by weight of solids is added thereto and mixed, until the mixture becomes uniform to provide a composition for a protective layer.

### Comparative Preparation Example 2: Preparation of Composition for Protective Layer

A composition for a protective layer is prepared according to the same method as Preparation Example 3 except that an initiator represented by Chemical Formula Y (a cation initiator including PF₆⁻) is used instead of the initiator represented by Chemical Formula X.

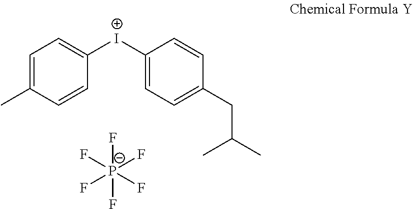 [SMILES: Cc1ccc([I+]c2ccc(CC(C)C)cc2)cc1 ; F[P-](F)(F)(F)(F)F]

### Comparative Preparation Example 3: Preparation of Composition for Protective Layer

A composition for a protective layer is prepared according to the same method as Preparation Example 3 except that an initiator represented by Chemical Formula Z is used instead of the initiator represented by Chemical Formula X.

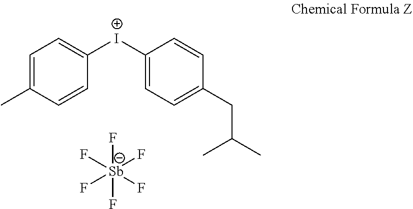

### Comparative Preparation Example 4: Preparation of Composition for Conductive Layer

1.5 g of ATO (KO-606 A, DaeHa ManTech Co., Ltd.) dispersed in an organic solvent and 2.7 g of multi-functional urethane acrylate (MU9800, Miwon Specialty Chemical Co., Ltd.) are dissolved in 2.7 g of methylisobutylketone, and 2.5 parts by weight of Irgacure 184 as a photoinitiator based on 100 parts by weight of solids and stirred, until the mixture becomes uniform to provide a composition for a conductive layer.

### EXAMPLE 1

The composition for a conductive layer according to Preparation Example 1 is coated with a bar #5 on a 50 μm-thick polyimide film (PI) and dried at 80° C. for 3 minutes. Subsequently, a mercury lamp (LC6B, Fusion UV System, Inc.) is used to cure the coated composition with a light dose of 300 millijoules per square centimeter (mJ/cm²) to form a 1 micrometer (μm) thick conductive layer. The sheet resistance of the conductive layer is measured. The composition for a protective layer according to Preparation Example 3 is then used to coat the conductive layer with a bar #16 and then, dried at 100° C. for 3 minutes. The mercury lamp (LC6B, Fusion UV System, Inc.) is used to cure the coated composition with a light dose of 200 mJ/cm² to form an 8 μm thick protective layer to provide a stacked structure.

### EXAMPLE 2

A stacked structure is made according to the same method as Example 1 except that the composition for a conductive layer according to Preparation Example 2 is used instead of the composition for a conductive layer according to Preparation Example 1.

### Comparative Example 1

The composition for a protective layer according to Preparation Example 3 is coated with a bar #16 on a 50 μm thick polyimide film and then, dried at 100° C. for 3 minutes. A mercury lamp (LC6B, Fusion UV System, Inc.) is used to cure the coated composition with a light dose of 200 mJ/cm² to form an 8 μm thick protective layer to provide a stacked structure.

### Comparative Example 2

A stacked structure is made according to the same method as Example 1 except that the composition for a conductive layer according to Comparative Preparation Example 1 is used instead of the composition for a conductive layer according to Preparation Example 3.

### Comparative Example 3

A stacked structure is made according to the same method as Example 1 except that the composition for a conductive layer according to Comparative Preparation Example 2 is used instead of the composition for a conductive layer according to Preparation Example 3.

### Comparative Example 4

A stacked structure is made according to the same method as Example 1 except that the composition for a conductive layer according to Comparative Preparation Example 3 is used instead of the composition for a conductive layer according to Preparation Example 3.

### Comparative Example 5

A stacked structure is made according to the same method as Example 2 except that the composition for a conductive layer according to Comparative Preparation Example 1 is used instead of the composition for a conductive layer according to Preparation Example 3.

### Comparative Example 6

A stacked structure is made according to the same method as Example 2 except that the composition for a conductive layer according to Comparative Preparation Example 2 is used instead of the composition for a conductive layer according to Preparation Example 3.

### Comparative Example 7

A stacked structure is made according to the same method as Example 2 except that the composition for a conductive layer according to Comparative Preparation Example 3 is used instead of the composition for a conductive layer according to Preparation Example 3.

### Comparative Example 8

The composition for a conductive layer according to Comparative Preparation Example 4 is coated with a bar #5 on a 50 μm thick polyimide film and dried at 80° C. for 3 minutes. A mercury lamp (LC6B, Fusion UV System, Inc.) is used to cure the coated composition with a light dose of 300 mJ/cm² to form a 1 μm thick conductive layer to provide a stacked structure.

### EVALUATION I

Scratch resistance characteristics, sheet resistance, and optical properties of the stacked structures according to Examples 1 and 2 and Comparative Examples 1 to 8 are evaluated.

The scratch resistance characteristics are evaluated by a scuff test (COAD.108, Ocean Science).

Specifically, the scratch resistance characteristics are evaluated by fixing the stacked structures according to Examples 1 and 2 and Comparative Examples 1 to 8 and then, putting a Φ20 cylinder wound with steel wool #0000 on the films. After putting a weight of 1.5 Kg on a pendulum connected to the cylinder, the pendulum connected to the cylinder is 50 times moved back and forth at 45 times/min. A determination of whether or not a scratch is generated on the surface of the stacked structures are examined with naked eyes.

Sheet resistance is measured by using a sheet resistance measuring equipment (MCP-HT450, Mitsubishi Chemical Analytech Co., Ltd.). The sheet resistance equipment is calibrated with a standard sample before working measurement are conducted. A circular probe is put on the sample, and sheet resistance is measured as 100 V of a voltage is applied for 60 seconds.

The light transmittance and the haze are measured by using a UV spectrometer (Spectrophotometer cm-3600d, Konica Minolta Inc.). The haze is measured according to D1003-97 A, and the yellow index is measured according to D1925. The transmittance is measured as a percent transmittance (Trans. %) at a wavelength of 550 nm.

The results are shown in Table 1.

TABLE 1

| | Scratch | Optical properties | | Sheet resistance (Ω/sq.) | |
|---|---|---|---|---|---|
| | resis- | Trans. % | | Conductive | Stacked |
| | tance* | (550 nm) | Haze | layer | structure |
| Example 1 | Pass | 90 | 0.6 | 2 × 10⁹ | 2 × 10¹⁰ |
| Example 2 | Pass | 90 | 0.7 | 4 × 10¹⁰ | 8 × 10¹⁰ |
| Comp. Example 1 | Pass | 91 | 0.6 | — | 1 × 10¹² |
| Comp. Example 2 | Pass | 90 | 0.7 | 2 × 10⁹ | >10¹⁴ |
| Comp. Example 3 | Pass | 90 | 0.7 | 2 × 10⁹ | >10¹⁴ |
| Comp. Example 4 | Pass | 90 | 0.7 | 2 × 10⁹ | >10¹⁴ |
| Comp. Example 5 | Pass | 90 | 0.7 | 4 × 10¹⁰ | >10¹⁴ |
| Comp. Example 6 | Pass | 90 | 0.7 | 4 × 10¹⁰ | >10¹⁴ |
| Comp. Example 7 | Pass | 90 | 0.7 | 4 × 10¹⁰ | >10¹⁴ |
| Comp. Example 8 | Pass | 89 | 1.2 | 4 × 10¹⁰ | — |
| PI | NG | 88.5 | 0.6 | — | >10¹⁴ |

*Pass: No scratch with naked eye.
*Fail: A plurality of scratches is found with naked eye.

Referring to Table 1, the stacked structures according to Examples exhibit improved scratch resistance characteristics and sheet resistance compared with the stacked structures according to the Comparative Examples.

### EXAMPLE II

### EXAMPLE 3

The composition for a conductive layer according to Preparation Example 1 is coated with a bar #5 on a 1.0 t-PMMA/PC film and dried at 80° C. for 3 minutes. A mercury lamp (LC6B, Fusion UV System, Inc.) is used to cure the coated composition with a light dose of 300 mJ/cm² to form a 1 μm thick conductive layer. The sheet resistance of the conductive layer is measured. The composition for a protective layer according to Preparation Example 3 is used to coat the conductive layer with a bar #16 and dried at 100° C. for 3 minutes. A mercury lamp (LC6B, Fusion UV System, Inc.) is used to cure the coated composition with a light dose of 200 mJ/cm² to form an 8 μm thick protective layer to provide a stacked structure.

### EXAMPLE 4

A stacked structure is made according to the same method as Example 3 except that the composition for a conductive layer according to Comparative Preparation Example 2 is used instead of the composition for a conductive layer according to Preparation Example 1.

### Comparative Example 9

The composition for a protective layer according to Preparation Example 3 is coated with a bar #16 on a 1.0 t-PMMA/PC film and dried at 100° C. for 3 minutes. A mercury lamp (LC6B, Fusion UV System, Inc.) is used to cure the coated composition with a light dose of 200 mJ/cm² to form an 8 μm thick protective layer and thus manufacture a stacked structure.

### Comparative Example 10

A stacked structure is made according to the same method as Example 3 except that the composition for a conductive layer according to Comparative Preparation Example 1 is used instead of the composition for a conductive layer according to Preparation Example 3.

### Comparative Example 11

A stacked structure is made according to the same method as Example 4 except that the composition for a conductive layer according to Comparative Preparation Example 1 is used instead of the composition for a conductive layer according to Preparation Example 3.

### EVALUATION II

Scratch resistance characteristics, sheet resistance, and optical properties of the stacked structures according to Examples 3 and 4 and Comparative Examples 9, 10, and 11 are evaluated.

The pencil hardness is evaluated by measuring pencil scratch hardness using an automatic pencil scratch hardness tester (No. 553-M1, YASUDA SEIKI SEISAKUSHO LTD.) and a Mitsubishi pencil according to ASTM D3363 standard. Specifically, the pencil hardness is evaluated as the highest pencil hardness)without defects by and moving a pencil 10 millimeter (mm) back and forth five times on an upper surface of the stacked structure at 60 millimeter per minute (mm/min) with a vertical load of 1 kilogram (kg). The results are shown in Table 2.

TABLE 2

| | | Optical properties | | Sheet resistance (Ω/sq.) | |
|---|---|---|---|---|---|
| | Pencil | Trans. % | | Conductive | |
| | hardness | (@550 nm) | Haze | layer | Stacked structure |
| Example 3 | 6H | 90 | 0.4 | 2 × 10⁹ | 4 × 10¹⁰ |
| Example 4 | 6H | 90 | 0.5 | 4 × 10¹⁰ | 7 × 10¹⁰ |
| Comp. Example 9 | 6H | 91 | 0.3 | — | 1 × 10¹² |
| Comp. Example 10 | 6H | 90 | 0.3 | 2 × 10⁹ | >10¹⁴ |
| Comp. Example 11 | 6H | 90 | 0.5 | 8 × 10⁹ | >10¹⁴ |
| PMMA/PC | 1-2H | 90 | 0.2 | — | >10¹⁴ |

Referring to Table 2, the stacked structures according to Examples exhibit improved scratch resistance characteristics and sheet resistance compared with the stacked structures according to the Comparative Examples.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A stacked structure comprising
a conductive layer on a substrate, and
a protective layer on the conductive layer, the protective layer comprising a cured product of a cation polymerizable compound and a cation initiator,
wherein the cation initiator comprises a cation and a resonance-stabilized counteranion.

2. The stacked structure of claim 1, wherein the resonance-stabilized counteranion of the cation initiator is represented by Chemical Formula 1:
M—(Ar)ₙ Chemical Formula 1
wherein, in Chemical Formula 1,
M is B, P, or Sb,
Ar is a C6 to C20 aryl group substituted with at least one halogen, and n is an integer of 4 to 6.

3. The stacked structure of claim 1, wherein the cation of the cation initiator comprises a resonance-stabilizing moiety that is the same or different as a resonance-stabilizing moiety of the counteranion.

4. The stacked structure of claim 1, wherein the cation polymerizable compound comprises at least one of an epoxy group and a vinyl group at a terminal end.

5. The stacked structure of claim 1, wherein the cation polymerizable compound comprises an organic compound comprising at least one of an epoxy group and a vinyl group at a terminal end, an organosiloxane comprising at least one of an epoxy group and a vinyl group at a terminal end, or a combination thereof.

6. The stacked structure of claim 1, wherein the cation polymerizable compound comprises a substituted or unsubstituted epoxy group, a substituted or unsubstituted glycidyl group, a substituted or unsubstituted glycidyl ether group, a substituted or unsubstituted glycidyl ester group, a substituted or unsubstituted oxetanyl group, a substituted or unsubstituted epoxycycloalkyl group, a substituted or unsubstituted vinyl group, a substituted or unsubstituted vinyl ether group, a substituted or unsubstituted styrenyl group, or a combination thereof.

7. The stacked structure of claim 1, wherein a sheet resistance of the conductive layer is less than or equal to about 8×10¹⁰ Ω/sq.

8. The stacked structure of claim 1, wherein the conductive layer comprises a metal, a carbon body, a conductive nanostructure, a conductive oxide, a conductive low molecule, a conductive polymer, ionic liquid, or a combination thereof, and the conductive layer has a sheet resistance of less than or equal to about 8×10¹⁰ ohms per square.

9. The stacked structure of claim 1, wherein the conductive layer is thinner than the protective layer.

10. The stacked structure of claim 1, wherein the substrate is a polymer substrate.

11. The stacked structure of claim 1, wherein a sheet resistance of the stacked structure is less than about 10¹¹ ohms per square.

12. The stacked structure of claim 1, wherein the sheet resistance of the stacked structure is about 1.1 times to about 30 times the sheet resistance of the conductive layer.

13. The stacked structure of claim 1, wherein the stacked structure satisfies a transmittance at 550 nanometers of greater than or equal to about 88% and a haze of less than or equal to about 1.0.

14. A window for an electronic device comprising the stacked structure of claim 1.

15. An electronic device comprising the window for an electronic device of claim 14.

16. An electronic device comprising the stacked structure of claim 1.

17. A method of manufacturing a stacked structure, the method comprising
forming a conductive layer on a substrate,
coating the conductive layer with a composition for a protective layer, and curing the composition to form a protective layer, wherein the composition for the protective layer comprises
a cation polymerizable compound, and
a cation initiator comprising a cation and a resonance-stabilized counteranion.

18. The method of claim 17, wherein the resonance-stabilized counteranion of the cation initiator is represented by Chemical Formula 1:
M—(Ar)ₙ 1 Chemical Formula 1
wherein, in Chemical Formula 1,
M is B, P, or Sb,
Ar is a C6 to C20 aryl group substituted with at least one halogen, and
n is an integer of 4 to 6.

19. The method of claim 17, wherein the cation of the cation initiator comprises a resonance-stabilizing moiety that is the same or different as a resonance-stabilizing moiety of the counteranion.

20. The method of claim 17, wherein the cation polymerizable compound comprises an organic compound comprising at least one of an epoxy group and a vinyl group at a terminal end, an organosiloxane comprising at least one of an epoxy group and a vinyl group at to terminal end, or a combination thereof.

21. The method of claim 17, wherein the cation polymerizable compound comprises a substituted or unsubstituted epoxy group, a substituted or unsubstituted glycidyl group, a substituted or unsubstituted glycidyl ether group, a substituted or unsubstituted glycidyl ester group, a substituted or unsubstituted oxetanyl group, a substituted or unsubstituted epoxycycloalkyl group, a substituted or unsubstituted vinyl group, a substituted or unsubstituted vinyl ether group, a substituted or unsubstituted styrenyl group, or a combination thereof.

22. The electronic device of claim 15, wherein the window is associated with an organic light emitting diode display, a bendable organic light emitting diode display device, a foldable organic light emitting diode display device, or a rollable organic light emitting diode display device, a quantum dot display device, a bendable a quantum dot display device, a quantum dot foldable display device, or a quantum dot rollable display device.
